(19) United States
(12) Patent Application Publication
(10) Pub. No.: US 2006/0053990 A1
(43) Pub. Date: Mar. 16, 2006

(54) Sawmill log speed adjustment system using saw deflection information

(76) Inventor: Earl M. Barker, Enumclaw, WA (US)

Correspondence Address: JENSEN + PUNTIGAM, P.S., SUITE 1020, 2033 6TH AVE, SEATTLE, WA, 98121, US

(21) Appl. No.: 10/942,575

(22) Filed: Sep. 16, 2004

(51) Int. Cl. B23D 55/00

(52) U.S. Cl. 83/74; 83/788; 144/378

(57) ABSTRACT

The log feed speed adjustment system includes a laser system for determining deflection of a saw at specified intervals during sawing of a log. A processing system compares the determined saw deflection against preestablished deflection values to determine whether the speed of the log feed should be increased or decreased relative to an initial log speed feed value. A control system changes the log feed speed accordingly. The log feed speed is decreased at a faster predetermined rate than it is increased.

### TECHNICAL FIELD

This invention relates generally to log sawing systems used in a commercial sawmill, and more particularly concerns log speed adjustment for such systems.

### BACKGROUND OF THE INVENTION

Conventional sawmills typically use bandsaws to cut logs into dimension lumber. Controlling the speed of the logs into the bandsaws (log feed) is one way to increase productivity of the mill. There are current systems which monitor deflection of the saw and straightforwardly control the speed of the log feed accordingly. The present invention is an improvement in such systems which increases the overall productivity of the log sawing process in the mill, based on a selected speed-up/slow-down log feed methodology.

### SUMMARY OF THE INVENTION

Accordingly, the present invention is a log speed adjustment system for a sawmill, comprising: a system for determining at specified time intervals deflection of a saw as it saws a log; a processing system for comparing the determined saw deflection against preestablished saw deflection values to determine whether the speed of the log feed should be increased or decreased from an initial established speed, wherein the processing system also includes a maximum speed increase limit relative to the initial speed and a maximum speed decrease limit relative to the initial speed; and a control system for changing the log feed speed when an increase or decrease in speed is determined by said processing system, wherein log feed speed decreases at a faster predetermined rate than otherwise when the saw deflection is determined to be greater than a predetermined value and faster than any increase in log feed speed.

### BRIEF DESCRIPTION OF THE DRAWINGS

FIG. 1 is a simplified schematic view of a sawmill system showing a log being initially sawn by a pair of parallel bandsaws.

FIG. 2 is an end view of the sawmill system of FIG. 1.

FIG. 3 is a schematic view of a single laser monitor assembly used with the system of FIGS. 1 and 2.

FIG. 4 is a block diagram showing the system for implementing the log speed adjustment system of the present invention.

FIG. 5 is a chart plotting deflection against log feed speed for one embodiment of the present invention.

FIG. 6 is a computer screen showing the results of the speed adjustment system of the present invention.

### BEST MODE FOR CARRYING OUT THE INVENTION

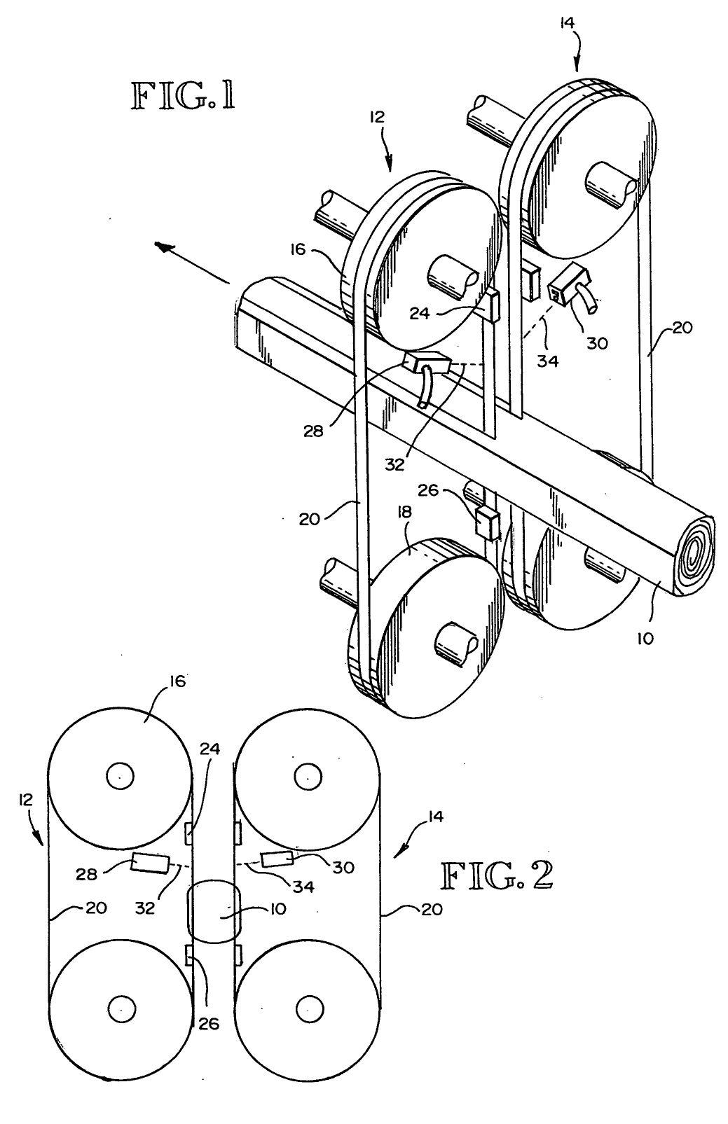

FIGS. 1 and 2 show in simplified form a “front end” of a sawmill system for sawing logs into dimension lumber, using parallel bandsaws, also referred to as twin bandsaws. FIG. 1 shows twin bandsaws making the first two parallel cuts, on opposite sides of the log, simultaneously. Additional cuts are then made, along with other conventional sawmill steps, to produce the finished dimension lumber.

Referring now specifically to FIGS. 1 and 2, a log 10 is fed into a sawing system, which in FIG. 1 includes parallel bandsaw (twin) assemblies 12 and 14. A typical speed at which a log is fed into the bandsaws during sawmill operation is in the range of 150-450 feet per minute, depending upon a number of factors, including physical characteristics of the log. In operation, an initial speed is selected, and the log is fed to the bandsaws at that speed.

Each bandsaw assembly includes two identical bandsaw wheels 16 and 18 disposed vertically relative to each other. Typically, bandsaw wheels 16 and 18 are separated by a distance of approximately 8-12 feet center to center, depending on the size of the wheels, which will vary from sawmill to sawmill. Extending around the two bandsaw wheels in each assembly is a bandsaw 20, which is held in tension by the bandsaw wheels, typically on the order of 20,000 lbs of tension. Although the system shown in FIGS. 1 and 2 show twin (left and right) bandsaw assemblies, it should be understood that a single bandsaw assembly can be used.

The system of FIGS. 1 and 2, with parallel bandsaws, cut left and right sides of an entering log simultaneously. After two opposing sides of the log are sawn as shown in FIGS. 1 and 2, the log is rotated and the other set of opposing sides sawn. The resulting sawn log can then be sawn again, perhaps multiple times, in accordance with a computer program for maximum results, and then finished to produce dimensional lumber.

Each bandsaw assembly includes upper and lower guide blocks 24 and 26, which are positioned inside the path of the saws and near where the saw contacts the respective bandsaw wheels 16 and 18 on each assembly. The upper guide blocks typically can be moved up and down, depending on the log diameter in order to improve sawing accuracy.

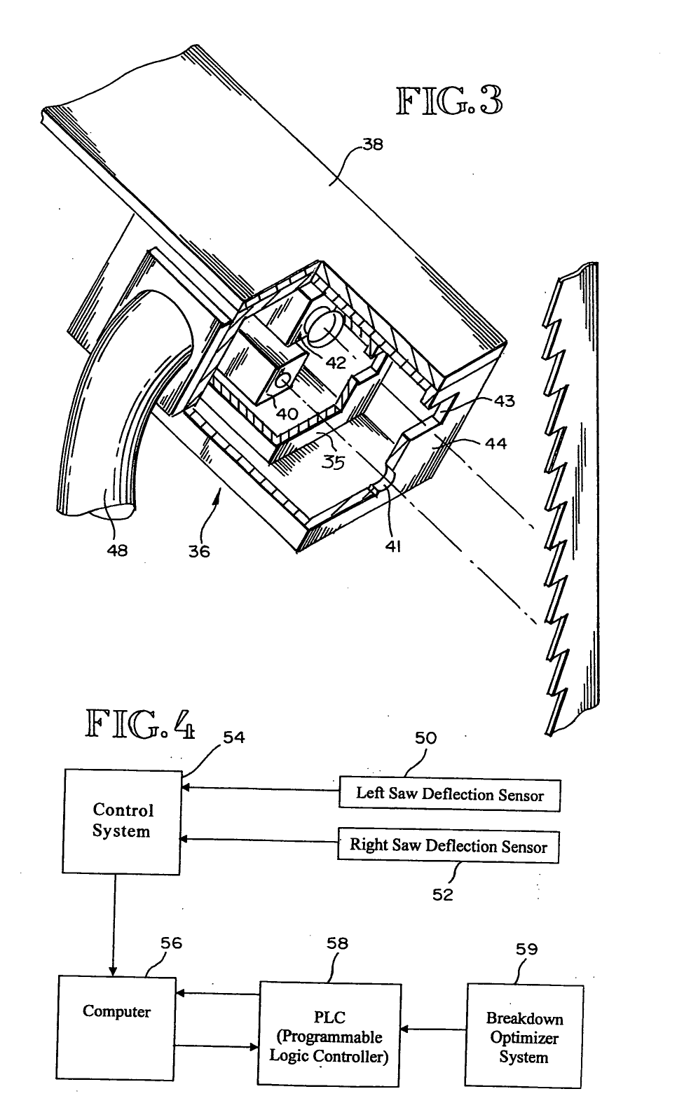

The system shown in FIG. 1 also includes a pair of laser systems 28 and 30 for monitoring the deflection of each saw. In the embodiment shown, the laser systems are mounted between the two vertical runs of each saw. Further, they are mounted so as to be movable, up and down. Each laser system is aimed at its associated saw at a spot between the guide blocks 24 and 26, typically a short distance below the upper guide block 24. The laser itself is positioned at a slight angle relative to the saw, as shown by the dotted lines 32 and 34, so as to prevent a direct reflection of the laser beam from the mirrored surface of the saw into a camera portion of the laser system. Each laser system 28 and 30 is mounted in a box 35, as shown in FIG. 3. Within the box 35 are a laser 40, a camera 42 and an industrial computer (not shown). The unit is generally referred to as a laser scanner. The laser scanner is mounted in a protective enclosure 36 which is made from 8-inch square metal tubing. Enclosure 36 is mounted on a gusset plate 38.

In the embodiment shown, two openings 41, 43 are provided in a near end 44 of enclosure 36, in registry with similar openings in box 35, one for the laser beam and one for the camera 42 to see the reflected beam from the saw. The enclosure arrangement reduces the amount of dust and other debris that can interfere with the laser in the harsh operating environment of a sawmill. In the embodiment shown, each laser system further includes a source of pressurized air which is delivered to the interior of each enclosure 36 through a flexible tube 48, to keep dust away from the laser scanner in the enclosure.

Referring now to FIG. 4, which shows the speed adjustment system of the present invention, the lasers for the left and right saws, referred to in FIG. 4 as the left and right deflection sensors 50 and 52, measure the actual deflection of the two saws dynamically, i.e. during actual log sawing operation. These measurements are made many times per second, in the embodiment shown typically 250 and up to 1,000 times per second, at the request of a control system 54. This data is a distance measurement, in thousandths of an inch. In certain arrangements, but not necessarily, data from saw deflection sensors 50 and 52 may be combined with data from similar sensors, i.e. other lasers, in other parts of the sawmill, for control of cutting decisions.

The control system 54 transmits the data from sensors 50 and 52 to a system computer 56, which determines the appropriate speed adjustment for the log feed, based on information received from the deflection sensors and in accordance with a speed evaluation program/table stored in the computer. After the computer 56 determines the correct speed, any change in speed is sent to a PLC 58, which actually controls the speed of the log feed.

Computer 56 receives specific information back from the PLC, including the current log feed speed, as well as the status of a photocell near the saws which confirms whether or not there is a log actually being cut by the saws. The PLC 58 also receives information from the log breakdown optimizer/analyzer 59, which scans each log with lasers and determines how to cut it for maximum return into dimension lumber. The PLC 58 will adjust the log feed speed up or down, depending upon the value of the signal from the computer 56, which calculates the speed adjustment. In the embodiment shown, the computation of speed changes is made and transmitted at 60 millisecond intervals, although this can be varied, depending upon the particular application.

In operation of the system, an initial feed speed is first determined, using conventional methods, and sawing of the log begins. An example of a typical initial speed might be 350 feet per minute, although this can be varied depending upon the sawmill system and the particular log being cut. The feed speed is then adjusted, based on saw deflection, using four user-adjustable parameters which define the control logic for the speed determination. The four parameters, including selected values for the present embodiment for those parameters, include a slow-down deflection limit, with a value of 0.04 inches, and a speed-up deflection limit, with a value of 0.02 inches, both of which refer to saw deflection values measured by the laser. The other two parameters are the slow-down speed limit, with a value of 50 feet per minute (FPM), and a speed-up speed limit, with a value of 30 FPM. The slow-down and speed-up limits are both in feet per minute and establish the maximum change, both decrease and increase, possible relative to the set initial speed. The selected values are examples and can be varied. The examples are appropriate for a particular system and are used to illustrate, in the description below, the system of the present invention and how it works.

In operation, deflection measurements are taken by the sensors 50, 52 at preestablished time intervals, e.g. 250 times per second. Using the above values as an example, if the measured deflection is greater than the 0.04 inch upper deflection limit, the system goes virtually immediately to the maximum value of slow-down (50 feet per minute from the above values). The slow-down continues until the deflection decreases below the upper slow-down deflection limit.

Likewise, if the value of the deflection is less than the speed-up deflection limit, which from the above values is 0.02 inches, the log feed speed is increased at the speed-up limit value (30 FPM from the above values) until the deflection is greater than 0.02, at which point the rate of speed-up will decrease. Changes in speed are made every 60 milliseconds in the embodiment shown.

The slow-down limit is greater than the speed-up limit. This has proven to be effective in the overall speed adjustment/productivity of the embodiment shown. In certain situations, however, the slow-down limit could be the same as the speed-up limit or even less.

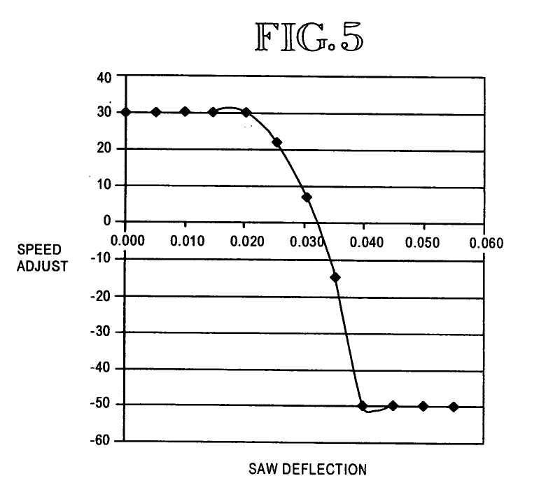

When the deflection is determined to be between 0.02 inches and 0.04 inches, the speed adjustment changes in accordance with a formula between the 30 FPM speed increase limit and the 50 FPM speed decrease limit from the initial speed. This is shown graphically in FIG. 5, in accordance with the formula set forth below. This is not a straight line change, but follows a selected pattern. It has been demonstrated that this arrangement is effective in increasing sawmill productivity. The speed adjustment formula is:
Speed adjust=C₁−C₂*saw deflectionˆC₃,
where C₁=speed-up speed limit in FPM+(speed-up deflection limit ˆC₃)*C₂, and C₂=(speed-up speed limit in FPM+slow-down speed limit in FPM)/(slow-down deflection limit ˆC₃−speed-up deflection limit ˆC₃), and where C₃ is equal to a constant.

Preferably, the constant C₃ is 4; the graph of FIG. 5 uses a C₃ constant of 4. The above formula results in a curved change in speed adjustment relative to saw deflection between the speed-up deflection limit and the deflection slow-down deflection limit. This arrangement results in higher productivity for the overall sawing operation.

When the saw first contacts an incoming log with the present system, the speed adjustment system does not immediately begin operating. The initial speed is not changed until 100 saw deflection measurements have been made. Computer 36 then computes an average of the last 20 measurements before it decides whether to slow the feed down. It computes an average of the last 50 measurements before it decides whether to speed up. The slow-down evaluation is made first, so as to make the slow-down decisions more responsive to possible saw problems, while at the same time making the speed-up decisions more conservative.

In the present embodiment, the system restricts speed-up commands to a maximum of 10 FPM increments, relative to the 60 ms time intervals of the system, so that increases in speed look like a staircase. Slow-downs, however, occur with no FPM restriction, so that if a high value of saw deflection is determined, a very quick slow-down can be made, while small deflections will produce increases in speed, but at a conservative pace. In the embodiment shown, where there is more than one saw in the system, the saw with the worst deflection controls the speed adjustment.

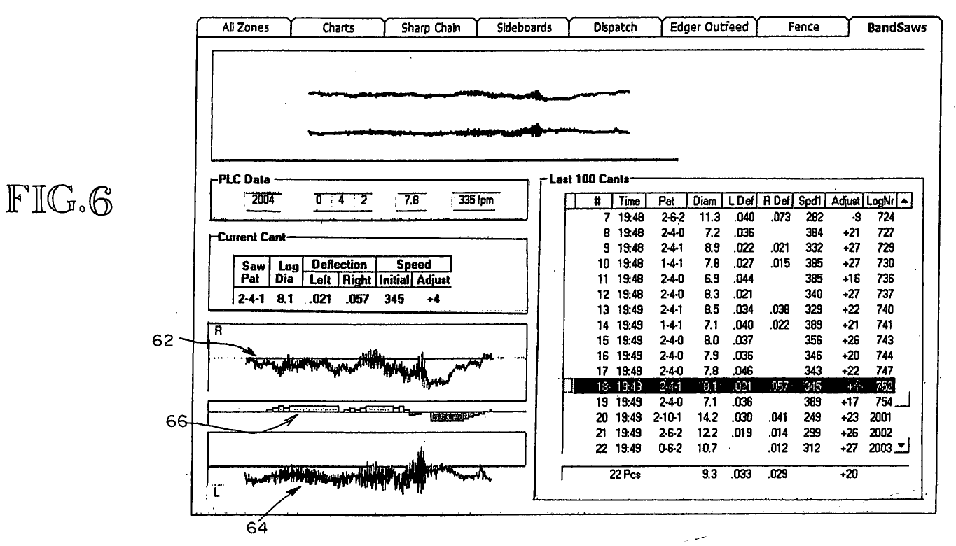

The screen display of FIG. 6 shows graphically the operation of the present system for a particular log over a relatively short time interval. The display shows the deflection data for the left and right saws at 62 and 64, respectively, while at 66, the actual speed increase/decrease relative to the initial speed is shown. The front of the log (start) is shown at the left end of 66.

In FIG. 6, after a period of time, the speed increased to a maximum of 30 FPM greater than the initial (nominal) speed. At some later point in time, the log slowed down to the original, initial speed, followed by a slow increase again to the maximum increase in speed value (30 FPM above the initial speed). Near the end of the log, the deflection on the right saw became quite large, and the log speed was reduced to 50 FPM below the initial speed. Following that, the deflection improved somewhat, with the speed being gradually increased in accordance with the program, until at the end, the feed speed was slightly greater than the initial speed. As indicated above, the speed adjustment occurs in the embodiment shown every 60 milliseconds, although this time can be varied.

Accordingly, a speed adjustment system has been shown and described which uses saw deflection measurements, accomplished by a laser system, for controlling log speed feed adjustment, within a boundary range of 50 FPM less than an initial log speed to a maximum log speed of 30 feet above the initial (nominal) log speed value.

Although a preferred embodiment of the invention has been disclosed for purposes of illustration, it should be understood that various changes, modifications and substitutions may be incorporated in the embodiment without departing from the spirit of the invention which is defined by the claims which follow.

What is claimed is:

1. A log feed speed adjustment system for a sawmill, comprising:
a system for determining at specified time intervals deflection of a saw as it saws a log;
a processing system for comparing the determined saw deflection against preestablished saw deflection values to determine whether the speed of the log feed should be increased or decreased from an initial established speed, wherein the processing system also includes a maximum speed increase limit relative to the initial speed and a maximum speed decrease limit relative to the initial speed; and
a control system for changing the log feed speed when an increase or decrease in speed is determined by said processing system, wherein log feed speed decreases at a faster predetermined rate than otherwise when the saw deflection is determined to be greater than a preselected value and faster than any increase in log feed speed.

2. The system of claim 1, wherein the limit for speed increase is approximately 30 feet per minute and wherein the limit for speed decrease is approximately 50 feet per minute.

3. The system of claim 1, wherein the log feed speed remains at the maximum speed increase limit as long as the deflection is no greater than a first deflection value, and wherein the log feed speed remains at the maximum speed decrease limit as long as the deflection is greater than a second deflection value.

4. The system of claim 3, wherein the first deflection value is approximately 0.02 inches and wherein the second deflection value is approximately 0.04 inches.

5. The system of claim 1, wherein saw deflection is determined by a laser system.

6. The system of claim 1, wherein log feed speed adjustment is determined approximately every 60 milliseconds.

7. The system of claim 1, wherein the log feed speed is determined according to a specified formula when the deflection is between a first value of saw deflection and a second, higher value of saw deflection.

8. The system of claim 7, wherein the formula for log feed speed change is as follows:
Speed adjust=C₁=C₂*saw deflectionˆC₃,
where C₁=speed-up speed limit in FPM+(speed-up deflection limit ˆC₃)*C₂, and C₂=(speed-up speed limit in FPM+slow-down speed limit in FPM)/(slow-down deflection limit ˆC₃−speed-up deflection limit ˆC₃), and where C₃ is equal to a constant.
